(19) United States
(12) Patent Application Publication
(10) Pub. No.: US 2011/0080734 A1
(43) Pub. Date: Apr. 7, 2011

(54) OPTICAL POINTING DEVICE

(76) Inventor: Chia-Yun Hsu, Taipei Hsien (TW)

(21) Appl. No.: 12/634,687

(22) Filed: Dec. 10, 2009

(30) Foreign Application Priority Data
Oct. 1, 2009 (TW) 098133380

(51) Int. Cl. G02B 27/20; F21V 7/00

(52) U.S. Cl. 362/259; 362/296.01; 362/297

(57) ABSTRACT

An optical pointing device includes a light source, a lens and a reflector. The light source is utilized to provide a light beam, and the lens is disposed on the light path of the light beam to focus the light beam. The reflector is disposed on the light path of the light beam between the light source and the lens for reflecting the light beam, so that the length of the optical pointing device can be reduced.

### BACKGROUND OF THE INVENTION

1. Field of the Invention

The present invention relates to an optical pointing device, and more particularly, to an optical pointing device having at least one reflector.

2. Description of the Prior Art

Lasers are widely utilized in daily life, in industry, and in many fields, and especially, a laser pointer is one of the most commonly used applications. The laser pointer uses optical components to focus or diffract a light beam emitted by a laser element to project on an object in a pattern such as a point, a line, or a specific pattern, so that the laser pointer can be applied as a teaching guide, used for horizontal and vertical measurement, or used for locating a position.

Please refer to FIG. 1. FIG. 1 is a schematic diagram illustrating a conventional optical pointing device. As shown in FIG. 1, the conventional optical pointing device 10 includes a light source 12 and a lens 14, and a laser light beam 16 emitted by the light source 12 can be directly focused to a predetermined position 18 through the lens 14. According to the product specification of the conventional optical pointing device 10, the laser light beam 16 is generally focused to a position at a distance about 3 meters from the lens 14, and the average diameter of the focused light spot at the distance about 3 meters from the lens 14 is required to be restricted within a specific width.

Please refer to FIGS. 2-4. FIG. 2 shows a relation between the light spot intensity and the light spot diameter at a distance of 3 meters from the conventional optical pointing device. FIG. 3 shows a relation between the light spot intensity and the light spot diameter at a distance of 3 meters from the conventional optical pointing device, while the lens of the conventional optical pointing device of FIG. 2 shifts by 0.05 mm in a direction away from the light source. FIG. 4 shows a relation between the light spot intensity and the light spot diameter at a distance of 3 meters from the conventional optical pointing device, while the lens of the conventional optical pointing device of FIG. 2 shifts by 0.05 mm in a direction toward the light source. As shown in FIG. 2, the average diameter of the focused light spot at the distance about 3 meters from the conventional optical pointing device 10 is substantially 3 mm. In addition, as shown in FIG. 3 and FIG. 4, while the distance between the lens 14 and the light source 12 shifts by 0.05 mm, the average diameter of the focused light spot increases from 3 mm to 5 mm. As a result, the average diameter of the focused light spot is strongly affected by the distance between the lens 14 and the light source 12. In order to conform the focused light spot to the product specification, the distance between the lens 14 and the light source 12 is required to be restricted within a fixed length, generally about 8.9 mm.

However, as technology advances, products become more miniaturized and more delicate as days go by. Optical pointing devices applied in all kinds of indicators such as laser pens or laser levels also have to be reduced in size. In order to conform to the product specification, the distance between the light source and the lens is still restricted to a fixed length, so that the length of the conventional optical pointing device along the direction of light output can not be reduced. Therefore, to miniaturize the optical pointing device by reducing the length of the optical pointing device along the direction of light output is an issue strongly required to be improved in the industry.

### SUMMARY OF THE INVENTION

It is therefore one objective of the present invention to provide an optical pointing device to reduce the length of the optical pointing device along the direction of light output, so that the demand for miniaturization and delicacy can be satisfied.

According to the present invention, an optical pointing device is provided. The optical pointing device includes a light source, a lens, and a reflector. The light source is utilized to provide a light beam, the lens disposed on a light path of the light beam is utilized to condense the light beam to a predetermined position, and the reflector disposed on the light path of the light beam between the light source and the lens is utilized to reflect the light beam.

According to the present invention, another optical pointing device is provided. The optical pointing device includes a light source, a reflector unit, and a lens. The light source is utilized to send a light beam, the reflector unit disposed on a light path of the light beam is utilized to reflect the light beam, and the lens is utilized to condense the light beam reflected from the reflector unit to a predetermined position.

In the optical pointing device of the present invention, the reflector is added on the light path between the light source and the lens, so that the light beam emitted from the light source can enter the lens by reflection. In this way, the length of the optical pointing device along the direction of light output can be reduced to satisfy the demand for miniaturization and delicacy.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating a conventional optical pointing device.

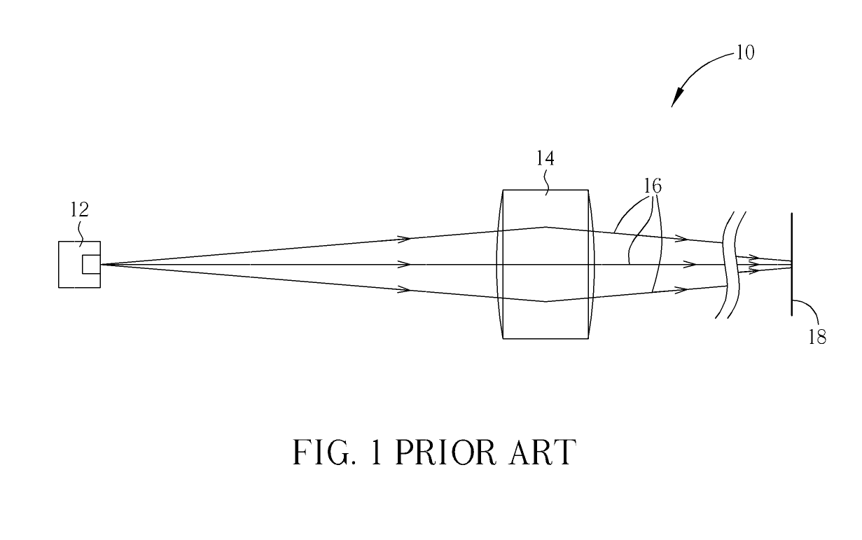

FIG. 2 shows a relation between the light spot intensity and the light spot diameter at a distance of 3 meters from the conventional optical pointing device.

FIG. 3 shows a relation between the light spot intensity and the light spot diameter at a distance of 3 meters from the conventional optical pointing device, while the lens of the conventional optical pointing device of FIG. 2 shifts by 0.05 mm in a direction away from the light source.

FIG. 4 shows a relation between the light spot intensity and the light spot diameter at a distance of 3 meters from the conventional optical pointing device, while the lens of the conventional optical pointing device of FIG. 2 shifts by 0.05 mm in a direction toward the light source.

FIG. 5 is a schematic diagram illustrating an optical pointing device according to a first embodiment of the present invention.

FIG. 6 is a schematic diagram illustrating an optical pointing device according to another example of the first embodiment of the present invention.

FIG. 7 is a schematic diagram illustrating an optical pointing device according to a second embodiment of the present invention.

FIG. 8 is a schematic diagram illustrating an optical pointing device according to a third embodiment of the present invention.

FIG. 9 is a schematic diagram illustrating an optical pointing device according to a fourth embodiment of the present invention.

FIG. 10 is a schematic diagram illustrating an optical pointing device according to a fifth embodiment of the present invention.

FIG. 11 is a schematic diagram illustrating an optical pointing device according to a sixth embodiment of the present invention.

FIG. 12 shows a relation between the light spot intensity and the light spot diameter at a distance of 3 meters from the optical pointing device of the present invention.

FIG. 13 shows a relation between the light spot intensity and the light spot diameter at a distance of 3 meters from the optical pointing device, while the lens of the optical pointing device of FIG. 12 shifts by 0.05 mm in a direction away from the light source.

FIG. 14 shows a relation between the light spot intensity and the light spot diameter at a distance of 3 meters from the optical pointing device, while the lens of the optical pointing device of FIG. 12 shifts by 0.05 mm in a direction toward the light source.

### DETAILED DESCRIPTION

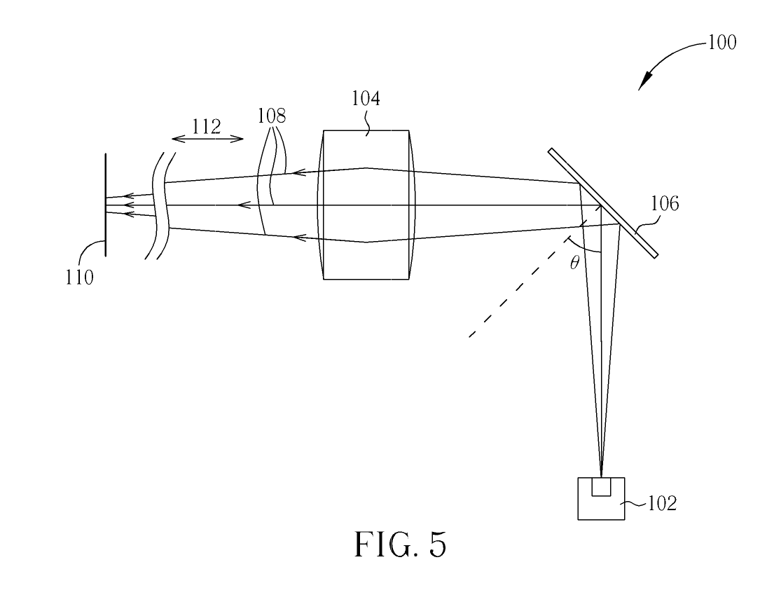

Please refer to FIG. 5. FIG. 5 is a schematic diagram illustrating an optical pointing device according to a first embodiment of the present invention. As shown in FIG. 5, the optical pointing device 100 of the present invention includes a light source 102, a lens 104, and a reflector 106, wherein the light source 102 may be a laser element, such as a semiconductor laser element, for providing a light beam 108, but the light source 102 is not limited to the laser element. The lens 104 is disposed on the light path of the light beam 108 to focus the light beam 108 to a predetermined position 110. In addition, the center line of the light beam 108 is preferably disposed on the optical axis of the lens 104, so that the light beam 108 after focused does not generate a long-rod shaped light spot on the image plane. The reflector 106 is disposed on the light path of the light beam 108 between the light source 102 and the lens 104, and the reflector 106 is utilized to reflect the light beam 108 to the lens 104. The light beam 108 after being reflected enters the lens 104 and the light beam 108 is then focused to the predetermined position 110. In this embodiment, the light source 102 and the lens 104 are disposed on the same side of the reflector 106.

In this embodiment, after the light beam 108 is emitted from the light source 102, the light beam 108 irradiates on the reflector 106 with an incident angle θ, the light beam 108 is reflected to the lens 104 with the same angle, and the light beam 108 is focused to the predetermined position 110 through the lens 104. Based on the image theory of lens, while the curvature of the lens 104 is fixed, an object with a definite object distance corresponds to an image with a specific image distance and a particular image size. In this embodiment, the object distance is the sum of the distance from the light source 102 to the reflector 106 and the distance from the reflector 106 to the lens 104, i.e. the length of the light path of the light beam 108 from the light source 102 to the center of the lens 104, such as 8.9 mm, and the image distance is the distance from the predetermined position 110 to the lens 104, such as 3 meters. Accordingly, while the length of the light path from the light source 102 to the center of the lens 104 is fixed, the predetermined position 110 where the light beam 108 is focused can be determined and the light spot diameter of the light beam 108 at the predetermined position 110 can also be determined.

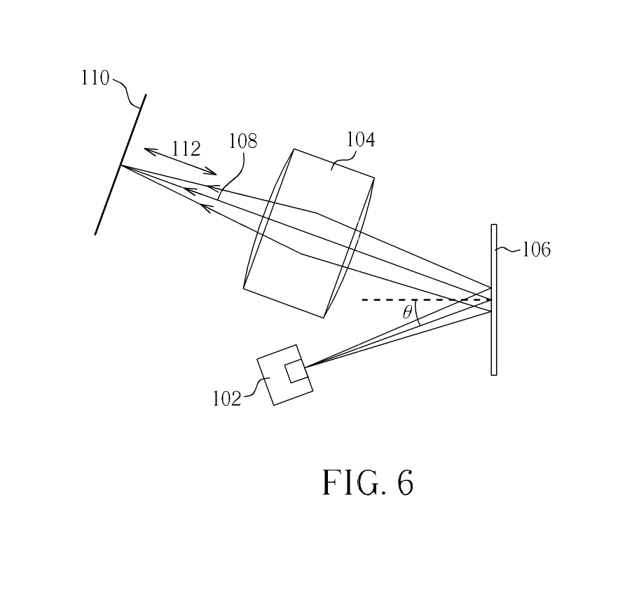

It should be noted that in this embodiment the light beam 108 emitted from the light source 102 is reflected by the reflector 106 and enters the lens 104, so that it differs from the conventional way that the light beam of the light source directly irradiates on the lens 104 and the direction of the light travel in this embodiment is changed. Therefore, under the condition of the fixed length of the light path, the length of the optical pointing device 100 along the direction of light output can be reduced. In this embodiment, the length of the optical pointing device 100 along the direction 112 of the light output depends on the distance between the lens 104 and the reflector 106. In addition, the angle between the optical axis of the light source 102 and the normal line of the reflector 106 is substantially 45 degrees in this embodiment, i.e. the incident angle θ in which the light beam irradiates on the reflector 106 is substantially 45 degrees, but the present invention is not limited herein. For example, the angle between the optical axis of the light source 102 and the normal line of the reflector 106 may be larger than 0 degrees and smaller than 90 degrees, and the angle between the optical axis of the light source 102 and the optical axis of the lens 104 may be preferably larger than 0 degrees and smaller than 45 degrees, so that the volume of the optical pointing device 100 may be effectively reduced. Please refer to FIG. 6. FIG. 6 is a schematic diagram illustrating an optical pointing device according to another example of the first embodiment of the present invention. As shown in FIG. 6, when the angle between the optical axis of the light source 102 and the optical axis of the lens 104 is reduced to an angle which is larger than 0 degrees and smaller than 45 degrees, the distance between the lens 104 and the light source 102 in FIG. 6 is shorter than the distance between the lens 104 and the light source 102 in FIG. 5. As a result, the total volume of the optical pointing device 100 can be reduced not only by decreasing the length of the optical pointing device 100 along the direction 112 of the light output, but also by shortening the distance between the lens 104 and the light source 102.

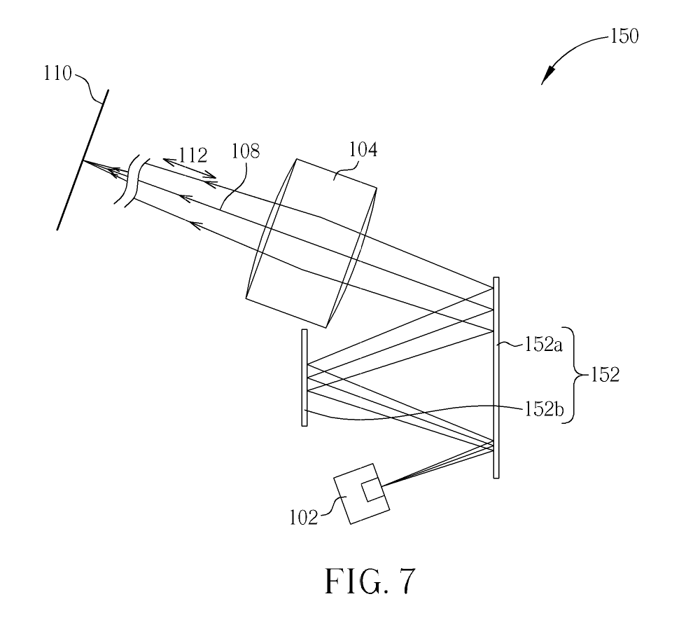

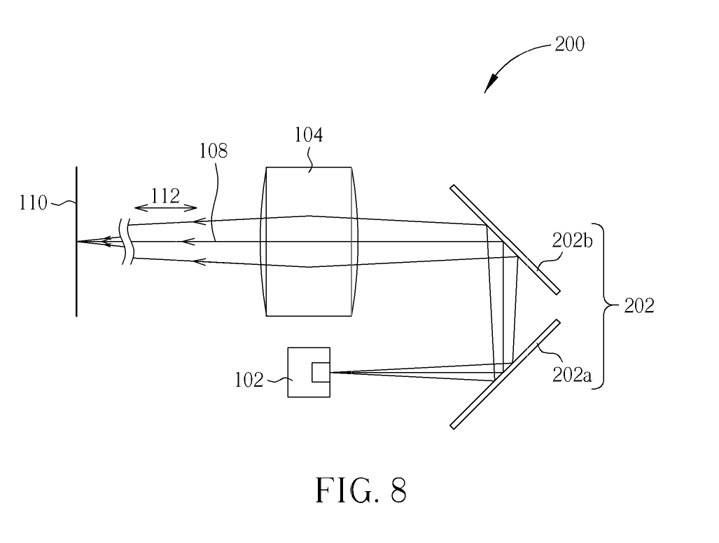

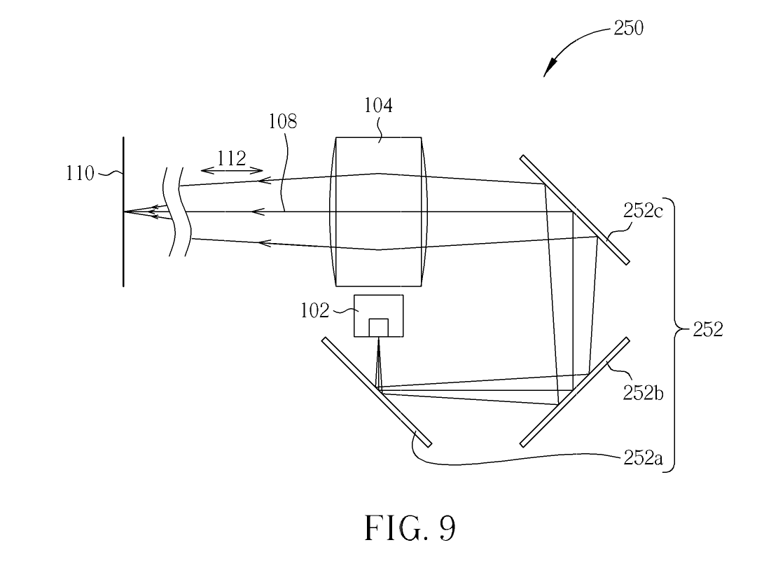

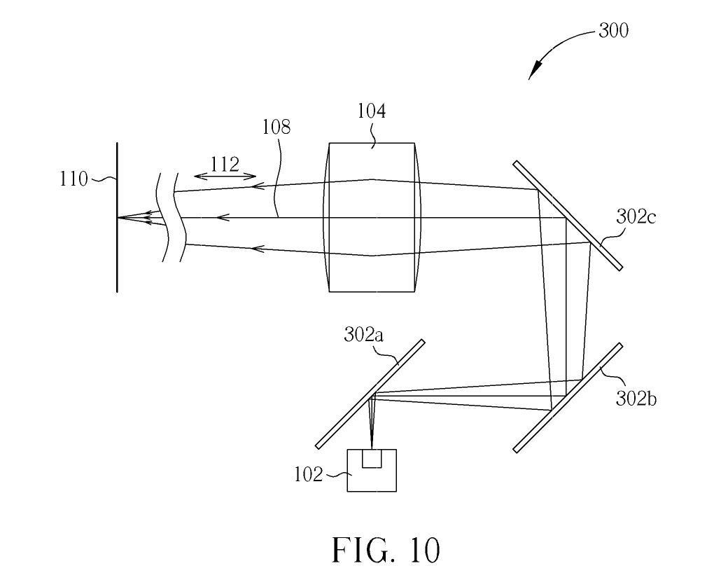

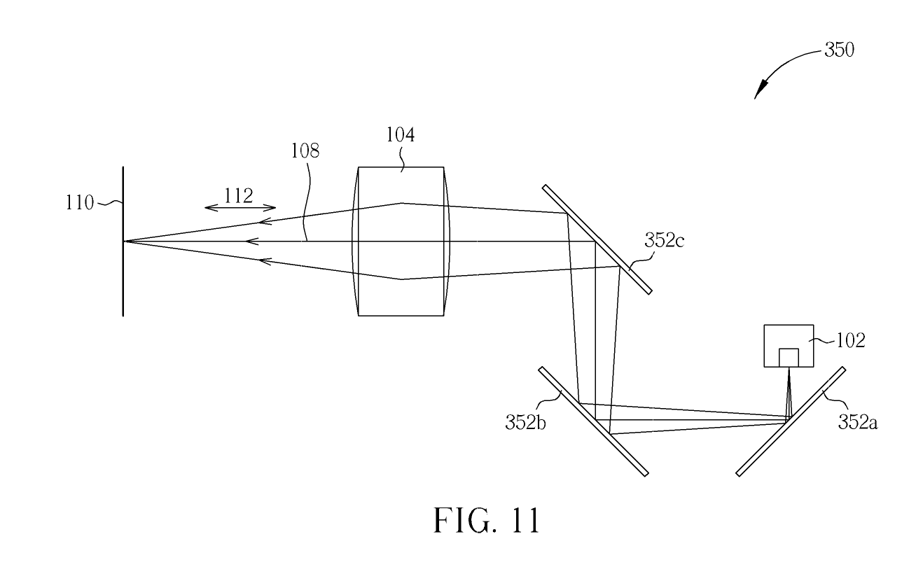

The optical pointing device of the present invention is not limited to having only one reflector and can have a plurality of reflectors. For the convenience of the explanation, the same elements in the following embodiments are indicated by the same symbols as used in the first embodiment. Please refer to FIGS. 7-11. FIG. 7 is a schematic diagram illustrating an optical pointing device according to a second embodiment of the present invention, FIG. 8 is a schematic diagram illustrating an optical pointing device according to a third embodiment of the present invention, FIG. 9 is a schematic diagram illustrating an optical pointing device according to a fourth embodiment of the present invention, FIG. 10 is a schematic diagram illustrating an optical pointing device according to a fifth embodiment of the present invention, and FIG. 11 is a schematic diagram illustrating an optical pointing device according to a sixth embodiment of the present invention. As shown in FIG. 7, compared with the first embodiment, the optical pointing device 150 of the second embodiment includes a light source 102, a reflector unit 152, and a lens 104, wherein the reflector unit 152 is disposed on the light path of the light beam 108 for reflecting the light beam 108, and the lens 104 is utilized to focus the light beam 108 reflected from the reflector unit 152 to a predetermined position 110. In addition, the reflector unit 152 includes a first reflector 152a and a second reflector 152b, wherein the first reflector 152a faces the light source 102 and is utilized to reflect the light beam 108 from the light source 102 to the second reflector 152b, and the second reflector 152b faces the first reflector 152a and is parallel to the first reflector 152a. The light beam 108 of this embodiment is reflected to the second reflector 152b by the first reflector 152a. Then, the light beam 108 is reflected to the first reflector 152a by the second reflector 152b. Following that, the light beam 108 is reflected by the first reflector 152a to and enters the lens 104 to be focused. The optical pointing device 100 of this embodiment utilizes the first reflector 152a and the second reflector 152b to change the light path of the light beam 108 by reflection, and the required length of the light path of the light beam 108 is fixed. Accordingly, the distance between the first reflector 152a and the second reflector 152b can be decreased to reduce the length of the optical pointing device 100 along the direction 112 of the light output. For the light beam 108 of this embodiment, the number of reflections on the first reflector 152a or the second reflector 152b is not limited herein, and the number of reflections can be adjusted depending on the required length of the light path in practice. In addition, the second reflector 152b of this embodiment is disposed between the light source 102 and the lens 104, but the present invention is not limited herein. For example, the second reflector may be disposed in a position close to the first reflector or away from the first reflector.

As shown in FIG. 8, compared with the second embodiment, the reflector unit 202 of the optical pointing device 200 according to the third embodiment includes a first reflector 202a and a second reflector 202b, wherein the second reflector 202b is perpendicular to the first reflector 202a, and the first reflector 202a and the second reflector 202b are disposed sequentially on the light path of the light beam 108 between the light source 102 and the lens 104. It should be noted that the optical axis of the light source 102 in this embodiment is substantially parallel to the optical axis of the lens 104, so that the light beam 108 of the light source 102 can be reflected by the first reflector 202a and the second reflector 202b to enter the optical axis of the lens 104. Since the second reflector 202b is added in this embodiment, the number of the reflections of the light beam 108 increases. Accordingly, under the condition of the fixed length of the light path from the light source 102 to the lens 104, the distance among the first reflector 202a, the second reflector 202b, the lens 104, and the light source 102 can be decreased to reduce the total volume of the optical pointing device 200 and the length of the optical pointing device 200 along the direction 112 of the light output. In addition, the light source 102 of this embodiment is disposed on one side of the lens 104, but the present invention is not limited herein. For example, the distance between the light source and the first reflector may be shorter or longer than the distance between the lens and the second reflector.

As shown in FIG. 9, compared with the second embodiment, the reflector unit 252 of the optical pointing device 250 according to the fourth embodiment includes a first reflector 252a, a second reflector 252b, and a third reflector 252c, wherein the first reflector 252a is adjacent to the light source 102, the third reflector 252c is adjacent to the lens 104, and the second reflector 252b is disposed between the first reflector 252a and the third reflector 252c. The first reflector 252a and the third reflector 252c are perpendicular to the second reflector 252b, and the first reflector 252a, the second reflector 252b, and the third reflector 252c are disposed sequentially on the light path of the light beam 108 between the light source 102 and the lens 104. It should be noted that, compared with the third embodiment, the third reflector 252c is added in this embodiment to increase the number of the reflections of the light beam 108 between the light source 102 and the lens 104, and the light path of the light beam 108 can be changed several times. Therefore, the distance among the first reflector 252a, the second reflector 252b, the third reflector 252c, the lens 104, and the light source 102 can be decreased, so that the total volume of the optical pointing device 250 and the length of the optical pointing device 250 along the direction 112 of the light output can be reduced. In this embodiment, the optical axis of the light source 102 is perpendicular to the optical axis of the lens 104, and the light source 102 is disposed between the lens 104 and the first reflector 252a.

The light source of the present invention is not limited to being disposed between the lens and the first reflector and can be disposed on another side of the first reflector opposite to the lens. For the convenience of the explanation, the same elements in the following embodiments are indicated by the same symbols as used in the fourth embodiment, and the portion of the same configuration is not described again. As shown in FIG. 10, compared with the fourth embodiment, the first reflector 302a and the second reflector 302b of the optical pointing device 300 according to the fifth embodiment are perpendicular to the third reflector 302c, and the first reflector 302a is disposed between the light source 102 and the lens 104.

In addition, the second reflector of the optical pointing device according to the present invention is not limited to being perpendicular to the third reflector. As shown in FIG. 11, compared with the fourth embodiment, the second reflector 352b and the third reflector 352c of the optical pointing device 350 according to the sixth embodiment are perpendicular to the first reflector 352a, and the second reflector 352b and the third reflector 352c are disposed between the light source 102 and the lens 104. Furthermore, the number of the reflectors is not limited to the number in the aforementioned embodiments and can be adjusted depending on the factors such as the volume of the optical pointing device, the length along the direction of the light output, or the manufacturing method in order to reach the effect of reducing the volume of the optical pointing device or decreasing the length along the direction of the light output. Moreover, the first reflector, the second reflector, and the third reflector mentioned previously are not limited to being respectively formed with three objects and may be three reflection surfaces on the same object or on at least one object.

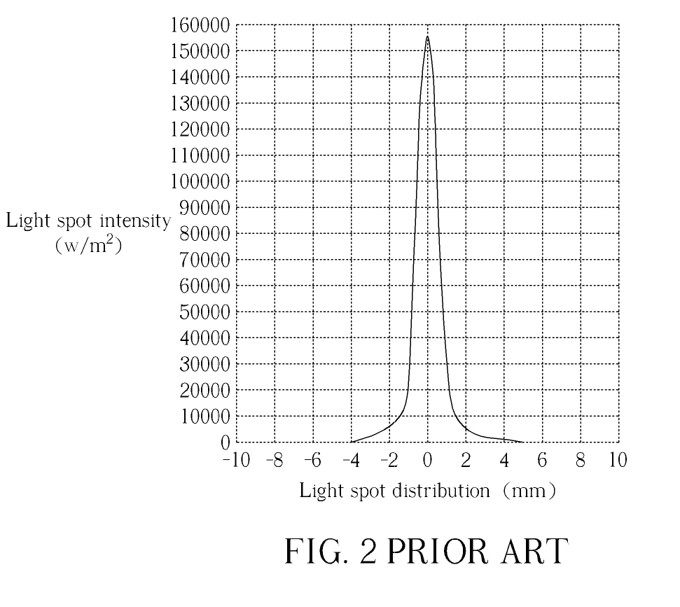

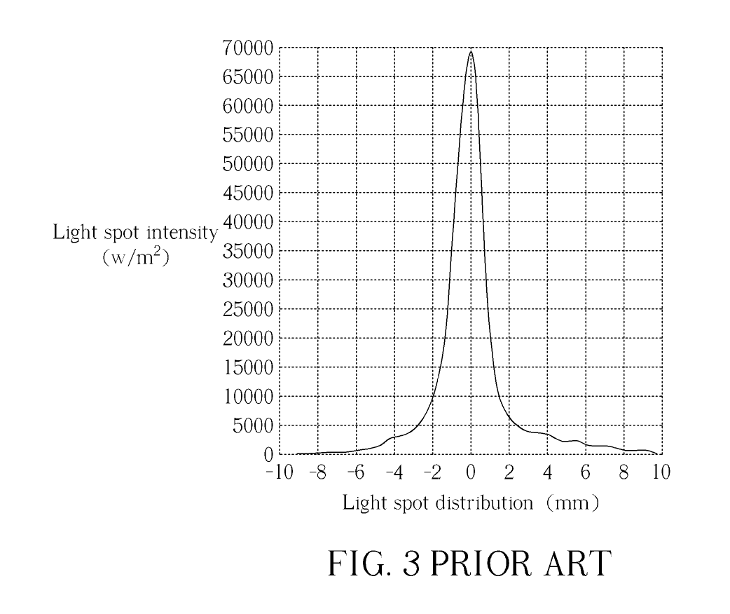

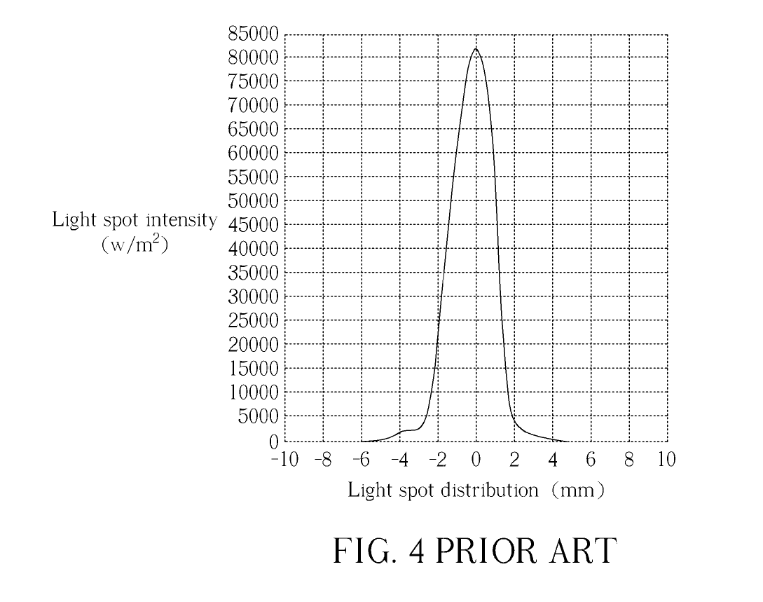

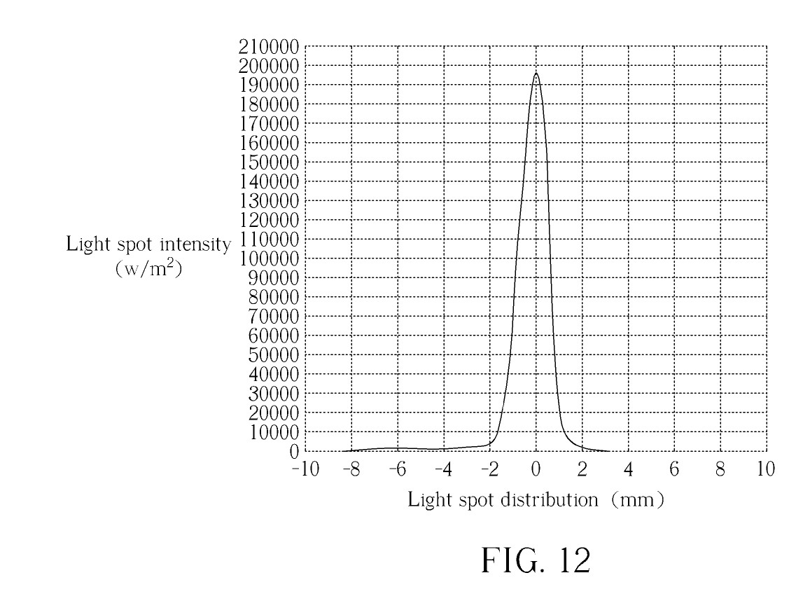

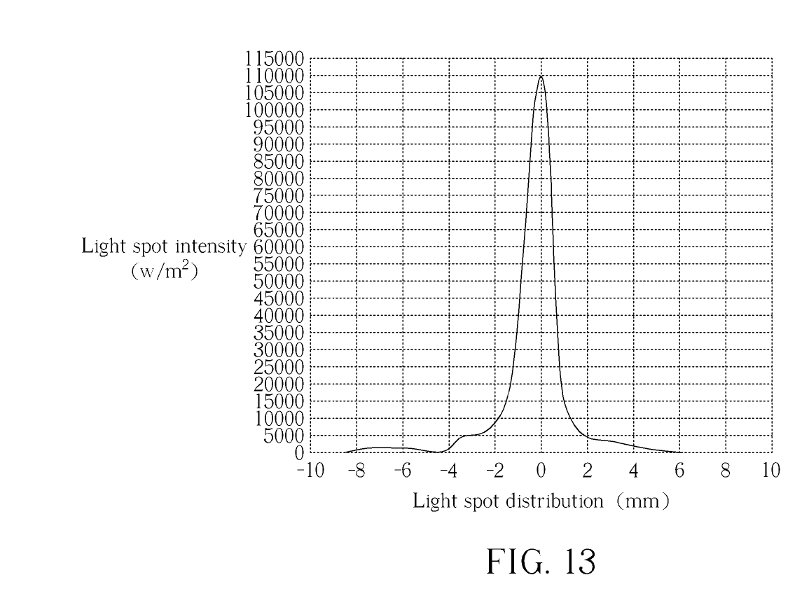

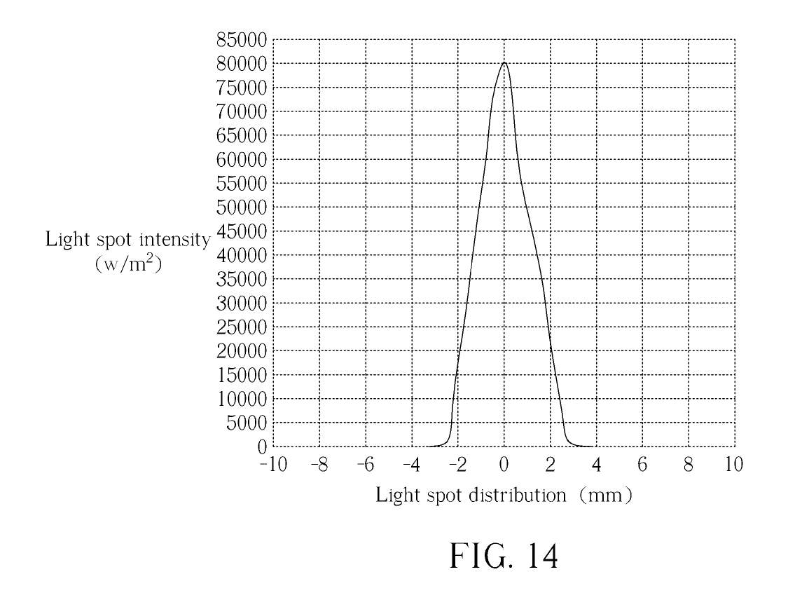

Furthermore, the effect on the average diameter of the focused light spot by adding the reflector in the present invention is clarified as follows. Please refer to FIGS. 12-14. FIG. 12 shows a relation between the light spot intensity and the light spot diameter at a distance of 3 meters from the optical pointing device of the present invention, FIG. 13 shows a relation between the light spot intensity and the light spot diameter at a distance of 3 meters from the optical pointing device, while the lens of the optical pointing device of FIG. 12 shifts by 0.05 mm in a direction away from the light source, and FIG. 14 shows a relation between the light spot intensity and the light spot diameter at a distance of 3 meters from the optical pointing device, while the lens of the optical pointing device of FIG. 12 shifts by 0.05 mm in a direction toward the light source. As shown in FIG. 12, the average light spot diameter at a distance of 3 meters from the optical pointing device is about 3.5 mm. In addition, as shown in FIG. 13, while the distance between the lens and the light source increases by 0.05 mm, the average light spot diameter increases from 3.5 mm to 4.5 mm. AS shown in FIG. 14, while the distance between the lens and the light source decreases by 0.05 mm, the average light spot diameter increases from 3.5 mm to 5.5 mm. Compared with the relation between the light spot intensity and the light spot diameter shown in FIGS. 2-4, the average light spot diameter of the present invention is not affected noticeably by adding the reflector, and the change of the average light spot diameter in the invention is substantially the same as the change in the conventional optical pointing device. Therefore, the addition of the reflector in this invention can reduce the volume of the optical pointing device and the length of the optical pointing device along the direction of the light output and does not affect the focused light spot.

In summary, at least one reflector is added in the optical pointing device of the present invention to reflect the light beam from the light source to the lens, so that the total volume of the optical pointing device and the length of the optical pointing device along the direction of the light output can be reduced to satisfy the demand for miniaturization and delicacy.

Those skilled in the art will readily observe that numerous modifications and alterations of the device and method may be made while retaining the teachings of the invention.

What is claimed is:

1. An optical pointing device, comprising:
a light source for providing a light beam;
a lens disposed on a light path of the light beam for condensing the light beam to a predetermined position; and
a reflector disposed on the light path of the light beam between the light source and the lens for reflecting the light beam to the lens.

2. The optical pointing device of claim 1, wherein the light source and the lens are disposed on the same side of the reflector, and an angle between an optical axis of the light source and a normal line of the reflector is larger than 0 degrees and smaller than 90 degrees.

3. The optical pointing device of claim 1, wherein the light beam of the light source irradiates on the reflector with an incident angle, the light beam is reflected to the lens with the same angle, and the light beam is focused to the predetermined position through the lens.

4. The optical pointing device of claim 1, wherein the light source is a laser element.

5. The optical pointing device of claim 1, wherein an optical axis of the lens is disposed on the light path of the light beam.

6. An optical pointing device, comprising:
a light source for emitting a light beam;
a reflector unit disposed on a light path of the light beam for reflecting the light beam; and
a lens for condensing the light beam reflected from the reflector unit to a predetermined position.

7. The optical pointing device of claim 6, wherein the reflector unit comprises a first reflector, a second reflector and a third reflector, the first reflector is adjacent to the light source, the third reflector is adjacent to the lens, and the second reflector is disposed between the first reflector and the third reflector.

8. The optical pointing device of claim 7, wherein the first reflector faces the light source and is utilized to reflect the light beam from the light source to the second reflector.

9. The optical pointing device of claim 8, wherein the second reflector is disposed on the light path of the light beam between the first reflector and the lens.

10. The optical pointing device of claim 7, wherein the second reflector faces the first reflector and the second reflector is parallel to the first reflector.

11. The optical pointing device of claim 7, wherein the second reflector faces the first reflector and the second reflector is perpendicular to the first reflector.

12. The optical pointing device of claim 7, wherein the third reflector is disposed on the light path of the light beam between the second reflector and the lens.

13. The optical pointing device of claim 12, wherein the first reflector and the third reflector are perpendicular to the second reflector.

14. The optical pointing device of claim 12, wherein the first reflector and the second reflector are perpendicular to the third reflector.

15. The optical pointing device of claim 12, wherein the second reflector and the third reflector are perpendicular to the first reflector.
